(19) United States
(12) Patent Application Publication
(10) Pub. No.: US 2023/0175552 A1
(43) Pub. Date: Jun. 8, 2023

(54) BEARING MATERIAL AND METHODS OF MAKING AND USING THE SAME

(71) Applicant: SAINT-GOBAIN PERFORMANCE PLASTICS PAMPUS GMBH, Willich (DE)

(72) Inventors: Beate THEIL, Willich (DE); Andreas Waldoefner, Duisburg (DE); Axelle Vuillerme, Neuss (DE); Vojko Pavsek, Willich (DE); Julia Ziegler, Leverkusen (DE)

(21) Appl. No.: 18/061,026

(22) Filed: Dec. 2, 2022

Related U.S. Application Data
(60) Provisional application No. 63/264,907, filed on Dec. 3, 2021.

(51) Int. Cl. F16C 33/12; C08L 27/18; C08K 3/013

(52) U.S. Cl. CPC F16C 33/12; C08L 27/18; C08K 3/013; F16C 2240/60

(57) ABSTRACT

A bearing material including a substrate, and a sliding layer overlying the substrate, where the sliding layer includes fillers including wollastonite in a wt % range between 10 and 30%, barium sulfate in a wt % range between 5 and 15%, and pigment in a wt % range between 0.1 and 5%.

### CROSS-REFERENCE TO RELATED APPLICATION(S)

This application claims priority under 35 U.S.C. § 119(e) to U.S. Provisional Application No. 63/264,907, entitled “BEARING MATERIAL AND METHODS OF MAKING AND USING THE SAME,” by Beate THEIL et al., filed Dec. 3, 2021, which is assigned to the current assignee hereof and incorporated herein by reference in its entirety.

### FIELD OF THE DISCLOSURE

The disclosure relates to a bearing material comprising a substrate and a sliding layer.

### BACKGROUND

Bearing materials which comprise a layer structure having a metallic support material or substrate and a sliding layer applied thereto have been known for a long time in a variety of forms from the prior art and are used in a wide variety of technical fields, for example in the field of automotive engineering. Currently, there exists a need to have bearing materials that use specific compositions to minimize coefficient of friction and maximize wear resistance between the bearing material and the mating surface of another component. As such, there is a continued need for improved bearing materials.

### BRIEF DESCRIPTION OF THE DRAWINGS

The present disclosure may be better understood, and its numerous features and advantages made apparent to those skilled in the art by referencing the accompanying drawings.

FIG. 1 illustrates an exemplary slide bearing in schematic sectional view;

FIG. 2A illustrates a cylindrical bearing that can be formed by rolling;

FIG. 2B illustrates a flanged bearing that can be formed by rolling and flanging;

FIG. 2C illustrates a flanged bearing having a tapered cylindrical portion that can be formed by rolling a tapered portion and flanging an end;

FIG. 2D illustrates a flanged bearing mounted in a housing with a shaft pin mounted through the flanged bearing;

FIG. 2E illustrates a two-sided flanged bearing mounted in a housing with a shaft pin mounted through the two-sided flanged bearing;

FIG. 2F illustrates an L type bearing that can be formed using a stamping and cold deep drawing process, rather than rolling and flanging;

FIG. 3 illustrates a line graph of coefficient of friction vs. time of bearing materials according to embodiments herein against a bearing material known in the art;

FIG. 4 illustrates a line graph of wear depth in μm vs. time of bearing materials according to embodiments herein against a bearing material known in the art;

FIG. 5 illustrates a photograph of worn steel ball that was running in contact with bearing materials according to embodiments herein against a bearing material known in the art.

The use of the same reference symbols in different drawings indicates similar or identical items.

### DETAILED DESCRIPTION

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. The use of the same reference symbols in different drawings indicates similar or identical items.

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the bearing material arts.

The structure of an exemplary bearing material 100 is shown in FIG. 1. The bearing material 100 may be used to form a bearing using conventional methods known in the art. As shown in FIG. 1, the substrate is denoted by 101, while 102 denotes the sliding layer applied thereto. In an embodiment, the substrate 101 is provided and the sliding layer 102 is applied to the substrate 101 such that it is overlying the substrate 101. In an embodiment, the sliding layer 102 is applied to the substrate 101 such that it is overlying and in direct contact with the substrate 101. In an embodiment, the sliding layer 102 is applied to the substrate 101 such that it is overlying the substrate 101 with intervening layers therebetween. It is contemplated herein that the bearing material 100 may include additional layers and compositions.

In an embodiment, the substrate 101 can at least partially include a metal. According to certain embodiments, the metal may include iron, copper, titanium, tin, aluminum, alloys thereof, or may be another type of material. More particularly, the substrate 101 can at least partially include a steel, such as, a stainless steel, carbon steel, or spring steel. For example, the substrate 101 can at least partially include a 301 stainless steel. The 301 stainless steel may be annealed, ¼ hard, ½ hard, ¾ hard, or full hard. Moreover, the steel can include stainless steel including chrome, nickel, or a combination thereof. In certain embodiments, the substrate 101 may include a woven mesh or an expanded metal grid. Alternatively, the woven mesh can be a woven polymer mesh. Further, in these alternative embodiments, the mesh structure of the substrate 101 may be embedded in the sliding layer 102. The substrate 101 may include conductive material.

In a number of embodiments, the substrate 101 may be spring steel. The spring steel substrate 101 may be annealed, ¼ hard, ½ hard, ¾ hard, or full hard. The spring steel substrate 101 may have a tensile strength of not less than 600 MPa, such as not less than 700 MPa, such as not less than 750 MPa, such as not less than 800 MPa, such as not less than 900 MPa, or such as not less than 1000 MPa. The spring steel substrate 101 may have a tensile strength of no greater than 1500 MPa, or such as no greater than 1250 MPa.

In one embodiment, the substrate 101 is cold-rolled steel. In another embodiment, the substrate 101 can be cold-rolled and subsequently zinc-plated steel, aluminium, aluminium-plated steel, or stainless steel. It is contemplated that ecologically problematical and disposal-intensive wet chemical pretreatment processes, in particular chromating, can be dispensed with.

The substrate 101 can be of any structure or shape. In embodiments, the substrate 101 can be a plate, a sheet, a woven fabric, a mesh, or metal foam. In an embodiment, the substrate can include steel, cold-rolled steel material No. 1.0338, cold-rolled steel material No. 1.0347, zinc-plated steel, stainless steel material No. 1.4512, stainless steel material No. 1.4720, stainless steel material No. 1.4310, aluminum, alloys, or any combinations thereof.

In another embodiment, the substrate 101 can have a coating. The coating can be a layer of another metal or alloy. In an embodiment, the coating is a metal or alloy containing at least one of the following metals: chromium, molybdenum, tungsten, manganese, iron, ruthenium, osmium, cobalt, rhodium, iridium, nickel, palladium, platinum, copper, silver, gold, zinc, aluminum, gallium, indium, silicon, germanium, tin, antimony, and bismuth. In yet another embodiment, the coating can be a copper alloy, a copper-tin alloy, a copper-zinc alloy, a bronze, a phosphor bronze, a silicon bronze, a brass, or any combination thereof.

In even one further embodiment, the substrate 101 can have a surface of a varying nature. The substrate 101 can have either a smooth surface, a roughened, or structured surface (for example, as achieved by brushing, sandblasting, embossing of a structure). Regardless of the surface roughness, the surface can also be modified to form a plated surface, such as a zinc-plated or aluminium-plated surface.

For example, surface roughness of the substrate 101 can be at least about 0.01 micron, at least about 0.02 micron, at least about 0.05 micron, at least about 0.1 micron, at least about 0.5 micron, at least about 1 micron, at least about 2 microns, at least about 5 microns, at least about 10 microns, at least about 20 microns, at least about 50 microns, at least about 100 microns, at least about 200 microns, or at least about 400 microns.

In another embodiment, the surface roughness can be less than about 400 microns, less than about 200 microns, less than about 100 microns, less than about 50 microns, less than about 25 microns, less than about 20 microns, less than about 15 microns, less than about 10 microns, less than about 5 microns, less than about 3 microns, less than about 2 microns, or even less than about 1 micron. In yet another embodiment, the substrate can have a surface roughness in the range from about 0.1 micron to about 400 microns, from about 0.5 micron to about 100 microns, or from about 1 micron to about 50 microns.

The surface of the substrate 101 can be treated by plating or coating to roughen, upgrade, or coat the surface. In another embodiment, the surface area of the substrate 101 can be increased by mechanical structuring. The structuring can include brush-finishing, sand-blasting, etching, perforating, pickling, punching, pressing, curling, deep drawing, decambering, incremental sheet forming, ironing, laser cutting, rolling, hammering, embossing, undercutting, and any combinations thereof. For example, embossing of a structure, allows for the possibility of intermeshing, which has a positive effect on the resulting bonding forces.

The substrate 101 can have a thickness Ts of at least about 0.05 mm, such as at least about 0.1 mm, at least about 0.15 mm, at least about 0.2 mm, at least about 0.25 mm, at least about 0.3 mm, at least about 0.35 mm, at least about 0.4 mm, or at least about 0.45 mm. The substrate 101 can have a thickness Ts of not greater than about 5 mm, not greater than about 4 mm, not greater than about 3 mm, not greater than about 2.5 mm, not greater than about 2 mm, not greater than about 1.5 mm, not greater than about 1 mm, not greater than about 0.9 mm, not greater than about 0.8 mm, not greater than about 0.7 mm, not greater than about 0.6 mm, not greater than about 0.55 mm, or not greater than about 0.5 mm. It will be further appreciated that the thickness Ts of the substrate 101 may be any value between any of the minimum and maximum values noted above. The thickness of the substrate 101 may be uniform, i.e., a thickness at a first location of the substrate 101 can be equal to a thickness at a second location therealong. The thickness of the substrate 101 may be non-uniform, i.e., a thickness at a first location of the substrate 101 can be different from a thickness at a second location therealong.

In a number of embodiments, the bearing material 100 can include a sliding layer 102. The sliding layer 102 can include a low friction material. Low friction materials may include, for example, a polymer, such as a polyketone, a polyaramid, a polyimide, a polytherimide, a polyphenylene sulfide, a polyethersulfone, a polysulfone, a polypheylene sulfone, a polyamideimide, ultra high molecular weight polyethylene, a fluoropolymer, a polyamide, a polybenzimidazole, or any combination thereof. In an example, the sliding layer 102 includes a polyketone, a polyaramid, a polyimide, a polyetherimide, a polyamideimide, a polyphenylene sulfide, a polyphenylene sulfone, a fluoropolymer, a polybenzimidazole, a derivation thereof, or a combination thereof. In a particular example, the low friction/wear resistant layer includes a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the low friction/wear resistant layer includes polyketone, such as polyether ether ketone (PEEK), polyether ketone, polyether ketone ketone, polyether ketone ether ketone, a derivative thereof, or a combination thereof. In an additional example, the low friction/wear resistant layer may be an ultra high molecular weight polyethylene. An example fluoropolymer includes fluorinated ethylene propylene (FEP), polytetrafluoroethylene (PTFE), polyvinylidene fluoride (PVDF), perfluoroalkoxy (PFA), polyoxymethylene (POM), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE). Further, the low friction/wear resistant layer could include polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. The sliding layer 102 may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, iron, bronze, steel, spring steel, stainless steel), a metal alloy (including the metals listed), an anodized metal (including the metals listed) or any combination thereof. Fluoropolymers may be used according to particular embodiments. As used herein, a “low friction material” can be a material having a dry static coefficient of friction as measured against steel of less than 0.5, such as less than 0.4, less than 0.3, or even less than 0.2. A “high friction material” can be a material having a dry static coefficient of friction as measured against steel of greater than 0.6, such as greater than 0.7, greater than 0.8, greater than 0.9, or even greater than 1.0. The sliding layer 102 may be an electrically non-conductive or low-conductive sliding material, e.g. includes a material that is non-conductive or low-conductive.

To improve the mechanical and general physical properties of the bearing material, the sliding layer 102 can contain fillers, pigments and/or dyes. Fillers can increase and/or improve the thermal conductivity and/or the wear properties. Fillers can be fibers, inorganic materials, thermoplastic materials, mineral materials, or mixtures thereof. For example, fibers can include glass fibers, carbon fibers, and aramids. Inorganic materials can include ceramic materials, carbon, glass, graphite, aluminium oxide, molybdenum sulfide, bronze, and silicon carbide. The inorganic materials can be in the form of woven fabrics, powders, spheres or fibers. Examples of thermoplastic materials can include polyimide (PI), polyamidimide (PAI), polyphenylene sulfide (PPS), polyoxymethylene (POM), polyphenylene sulfone (PPSO2), liquid crystal polymers (LCP), polyether ether ketones (PEEK), polyethersulfone (PES), polyetherketone (PEK), and aromatic polyesters (Ekonol), or mixtures thereof. Example of mineral materials can include wollastonite and barium sulfate. Fillers can be in the form of beads, fibers, powder, mesh, or any combination thereof. Fillers can be in the form of beads, fibers, powder, mesh, or any combination thereof.

The filler can be present in the sliding layer in an amount of at least about 1 vol %, at least about 5 vol %, at least about 10 vol %, at least about 15 vol %, at least about 20 vol %, at least about 25 vol %, at least about 30 vol %, at least about 35 vol %, at least about 40 vol %, at least about 50 vol %, at least about 60 vol %, at least about 70 vol %, at least about 80 vol %, or at least about 90 vol % based on the total volume of the sliding layer 102.

The filler can be present in the sliding layer in an amount of at least about 1 wt %, at least about 5 wt %, at least about 10 wt %, at least about 15 wt %, at least about 20 wt %, at least about 25 wt %, at least about 30 wt %, at least about 35 wt %, at least about 40 wt %, at least about 50 wt %, at least about 60 wt %, at least about 70 wt %, at least about 80 wt %, or at least about 90 wt % based on the total weight of the sliding layer 102.

In a number of embodiments, the sliding layer 102 may include a filler comprising wollastonite in a weight % of at least 0.1 wt % based on the total weight of the sliding layer 102, such as at least 0.5 wt %, as at least 1 wt %, as at least 5 wt %, as at least 10 wt %, as at least 15 wt %, as at least 20 wt %, as at least 25 wt %, or even 30 wt % based on the total weight of the sliding layer 102. In a number of embodiments, the sliding layer 102 may include a filler comprising wollastonite in a weight % of between 10 and 30% of the total weight of the sliding layer 102.

In a number of embodiments, the sliding layer 102 may include a filler comprising barium sulfate in a weight % of at least 0.1 wt % based on the total weight of the sliding layer 102, such as at least 0.5 wt %, as at least 1 wt %, as at least 5 wt %, as at least 10 wt %, as at least 15 wt %, as at least 20 wt %, as at least 25 wt %, or even 30 wt % based on the total weight of the sliding layer 102. In a number of embodiments, the sliding layer 102 may include a filler comprising barium sulfate in a weight % of between 5 and 15% of the total weight of the sliding layer 102.

In a number of embodiments, the sliding layer 102 may include a filler comprising pigment in a weight % of at least 0.1 wt % based on the total weight of the sliding layer 102, such as at least 0.5 wt %, as at least 1 wt %, as at least 5 wt %, as at least 10 wt %, as at least 15 wt %, as at least 20 wt %, as at least 25 wt %, or even 30 wt % based on the total weight of the sliding layer 102. In a number of embodiments, the sliding layer 102 may include a filler comprising pigment in a weight % of between 5 and 15% of the total weight of the sliding layer 102.

In one embodiment, the fillers may be in the form of particles in the continuous phase. The particles have a primary aspect ratio of at least about 2:1, at least about 3:1, at least about 4:1, or at least about 5:1. The primary aspect ratio means the ratio of the longest dimension over the second longest dimension, wherein the two dimensions are in orthogonal relation to each other.

In yet another embodiment, the filler particles have a secondary aspect ratio of at least about 1:1, at least about 2:1, at least about 3:1, or at least about 4:1. The secondary aspect ratio means the ratio of the second longest dimension over the third longest dimension, wherein the two dimensions are in orthogonal relation to each other.

In one further embodiment, at least 50 percent of the particles have a primary dimension not greater than about 30 microns, not greater than about 25 microns, not greater than about 20 microns, not greater than about 18 microns, not greater than about 15 microns, not greater than about 13 microns, or even not greater than about 10 microns.

In yet another embodiment, at least 50 percent of the filler particles have a secondary dimension not greater than about 20 microns, not greater than about 18 microns, not greater than about 15 microns, not greater than about 13 microns, not greater than about 10 microns, not greater than about 8 microns, not greater than about 5 microns, or not greater than about 3 microns.

In even one further embodiment, at least 50 percent of the filler particles have a tertiary dimension not greater than about 20 microns, not greater than about 18 microns, not greater than about 15 microns, not greater than about 13 microns, not greater than about 10 microns, not greater than about 8 microns, not greater than about 5 microns, not greater than about 3 microns.

In one particular embodiment, the filler particles have an inhomogeneous distribution in size throughout the sliding layer. An inhomogeneous size distribution in a sliding layer is established when there is a gradient of the primary dimension from the center of the sliding layer to the edges of the sliding layer. For example, in one embodiment, the particles in the center region, e.g., within 50 microns of the centerline of the sliding layer, can have an average droplet size larger than the particles in the edge region, i.e. within 50 microns of the surface or edge of the sliding layer. In one example, the average droplet size in the center region can be 7 microns gradually decreasing to an average droplet size in the edge region of 1 micron.

The sliding layer 102 applied to the substrate 101 can include an embedded fluoropolymer as an inclusion compound. Such compounds can be made from polytetrafluoroethylene (PTFE), polyamide (PA), polyether ether ketone (PEEK), or a mixture thereof. In a particular embodiment, the sliding layer 102 can include a PTFE inclusion compound.

In an embodiment, the sliding layer 102 can have a thickness T_{SL} of at least about 0.05 mm, such as at least about 0.1 mm, at least about 0.15 mm, at least about 0.2 mm, at least about 0.25 mm, at least about 0.3 mm, at least about 0.35 mm, at least about 0.4 mm, or at least about 0.45 mm. In an embodiment, the sliding layer 102 can have a thickness T_{SL} of not greater than about 5 mm, not greater than about 4 mm, not greater than about 3 mm, not greater than about 2.5 mm, not greater than about 2 mm, not greater than about 1.5 mm, not greater than about 1 mm, not greater than about 0.9 mm, not greater than about 0.8 mm, not greater than about 0.7 mm, not greater than about 0.6 mm, not greater than about 0.55 mm, or not greater than about 0.5 mm. It will be further appreciated that the thickness T_{SL} of the sliding layer 102 may be any value between any of the minimum and maximum values noted above. The thickness of the sliding layer 102 may be uniform, i.e., a thickness at a first location of the sliding layer 102 can be equal to a thickness at a second location therealong. The thickness of the sliding layer 102 may be non-uniform, i.e., a thickness at a first location of the sliding layer 102 can be different from a thickness at a second location therealong. It can be appreciated that different sliding layer 102 may have different thicknesses. The sliding layer 102 may overlie one major surface of the substrate 101, shown, or overlie both major surfaces. The substrate 101 may be at least partially encapsulated by the sliding layer 102. That is, the sliding layer 102 may cover at least a portion of the substrate 102. Axial surfaces of the substrate 102 may be exposed from the sliding layer 102.

In an embodiment, the sliding layer 102 may include an adhesive. The adhesive may include any known adhesive material common to the bearing arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C.

In one process, both the substrate and the sliding layer are in each case rolled off a roll as continuous material. Adhesive polymer is applied to the substrate and the layers may be joined to one another under pressure and at elevated temperature in a laminating apparatus. To achieve further-improved adhesion of the adhesive layer to the substrate together with improved corrosion properties of the substrate, an embodiment of the process provides for the surface of the substrate to be roughed and/or surface-upgraded. In other embodiments, the method can include coating the metal surface.

In an embodiment, any of the layers on the bearing material 100, as described above, can each be disposed in a roll and peeled therefrom to join together under pressure, at elevated temperatures (hot or cold pressed or rolled), by an adhesive, or by any combination thereof. Any of the layers of the bearing material 100, as described above, may be laminated together such that they at least partially overlap one another. Any of the layers on the bearing material 100, as described above, may be applied together using coating technique, such as, for example, physical or vapor deposition, spraying, plating, powder coating, or through other chemical or electrochemical techniques. In a particular embodiment, the sliding layer 102 may be applied by a roll-to-roll coating process, including for example, extrusion coating. The sliding layer 102 may be heated to a molten or semi-molten state and extruded through a slot die onto a major surface of the substrate 101. In another embodiment, the sliding layer 102 may be cast or molded.

In an embodiment, the sliding layer 102 or any layers can be glued to the substrate 101 using the adhesive to form a laminate. In an embodiment, any of the intervening or outstanding layers on the material or bearing material 100, may form the laminate. The laminate can be cut into strips or blanks that can be formed into the bearing. The cutting of the laminate may include use of a stamp, press, punch, saw, or may be machined in a different way. Cutting the laminate can create cut edges including an exposed portion of the substrate 101.

In other embodiments, any of the layers on the bearing material 100, as described above, may be applied by a coating technique, such as, for example, physical or vapor deposition, spraying, plating, powder coating, or through other chemical or electrochemical techniques. In a particular embodiment, the sliding layer 102 may be applied by a roll-to-roll coating process, including for example, extrusion coating. The sliding layer 102 may be heated to a molten or semi-molten state and extruded through a slot die onto a major surface of the substrate 101. In another embodiment, the sliding layer 102 may be cast or molded.

According to certain embodiments, the bearing material 100 may be formed into a bearing. Forming the bearing material 100 into a bearing may include a cutting operation to cut a blank of bearing material 100, then forming the blank into a finished or semi-finished bearing. Bearings can include plane bearings, annular bearings, balljoint bearings (half spheres), plain bearings, axial bearings, thrust bearings, linear bearings, bearing shells, bearing cups and combinations thereof. In an embodiment, the cutting operation may include use of a stamp, press, punch, saw, deep draw, or may be machined in a different way. After shaping the bearing, the bearing may be cleaned to remove any lubricants and oils used in the forming and shaping process. Additionally, cleaning can prepare the exposed surface of the substrate for the application of the coating. Cleaning may include chemical cleaning with solvents and/or mechanical cleaning, such as ultrasonic cleaning.

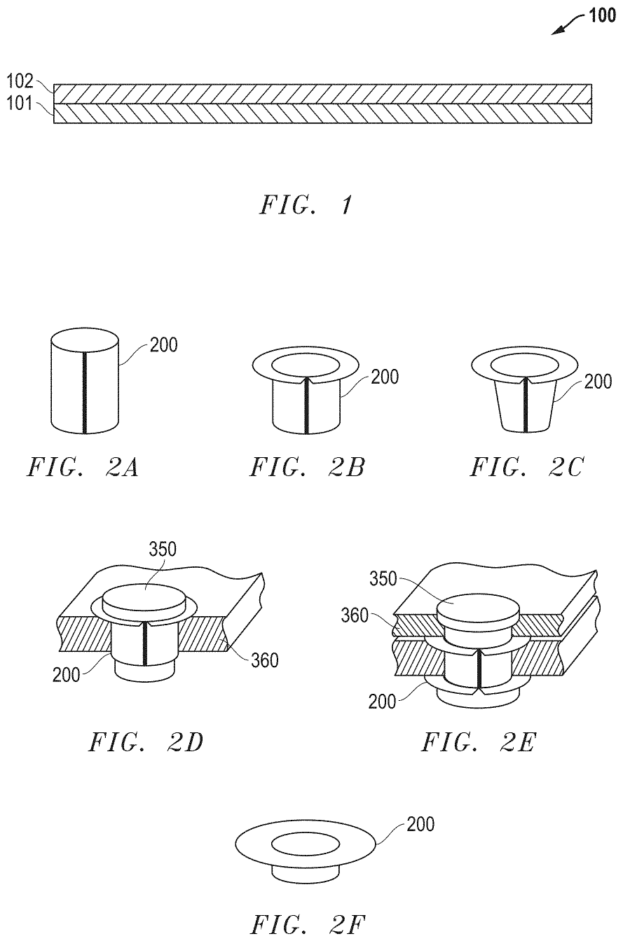

FIGS. 2A through 2F illustrate a number of bearing 200 shapes that can be formed from the bearing materials described herein. FIG. 2A illustrates a cylindrical bearing 200 that can be formed by rolling. FIG. 2B illustrates a flanged bearing 200 that can be formed by rolling and flanging. FIG. 2C illustrates a flanged bearing 200 having a tapered cylindrical portion that can be formed by rolling a tapered portion and flanging an end. FIG. 2D illustrates a flanged bearing 300 mounted in a housing with a shaft pin mounted through the flanged bearing 200. FIG. 2E illustrates a two-sided flanged bearing 200 mounted in a housing with a shaft pin mounted through the two-sided flanged bearing 200. FIG. 2F illustrates an L type bearing 200 that can be formed using a stamping and cold deep drawing process, rather than rolling and flanging. As shown in FIGS. 2D and 2E, the bearing 200 may then be placed between a first component (e.g. a shaft) 250 and a second component (e.g. a housing) 260 and provide a mating surface for at least one of the neighboring parts in an assembly.

Applications for embodiments include, for example, assemblies for hinges and other vehicle components. Further, use of the bearing material or assembly may provide increased benefits in several applications such as, but not limited to, door, hood, tailgate, and engine compartment hinges, seats, steering columns, flywheels, driveshaft assemblies, powertrain applications (such as belt tensioners), or other types of applications outside of vehicle components. Bearing materials are applied in a broad spectrum of commercial industry ranging from the heavy metal industry to the automotive and bike industry, even into baking industry, laptop/mobile phone hinges, bearings for solar applications and more. According to particular embodiments herein, the bearing material may surprisingly optimize wear performance and coefficient of friction between the bearing material and a mating surface within an assembly. Further, the pigment filler in some embodiments herein may have an improved aesthetic appearance. In addition, bearing materials according to embodiments herein reduce wear of the bearing material surface and the mating components, thereby increasing lifetime, improving visual appearance, and improving effectiveness and performance of the assembly, the bearing material, and its other components.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1: A bearing material comprising: a substrate, and a sliding layer overlying the substrate, wherein the sliding layer comprises fillers comprising wollastonite in a wt % range between 10 and 30%, barium sulfate in a wt % range between 5 and 15%, and pigment in a wt % range between 0.1 and 5%.

Embodiment 2: An assembly comprising: a first component; a second component; and a bearing located between the first component and the second component, the bearing comprising: a substrate, and a sliding layer overlying the substrate, wherein the sliding layer comprises fillers comprising wollastonite in a wt % range between 10 and 30%, barium sulfate in a wt % range between 5 and 15%, and pigment in a wt % range between 0.1 and 5%.

Embodiment 3: A method comprising: providing a substrate; applying a sliding layer to the substrate to provide a bearing material with a sliding layer overlying the substrate, wherein the sliding layer comprises fillers comprising wollastonite in a wt % range between 10 and 30%, barium sulfate in a wt % range between 5 and 15%, and pigment in a wt % range between 0.1 and 5%.

Embodiment 4: The bearing, assembly, or method according to any one of the preceding embodiments, wherein the bearing has a coefficient of friction of between 0.1 and 0.4 according to tribometer tests in three balls on plate setup.

Embodiment 5: The bearing, assembly, or method according to any one of the preceding embodiments, wherein the bearing has a wear rate of between 0.05 μm/h and 0.15 μm/h according to tribometer tests in three balls on plate setup.

Embodiment 6: The bearing, assembly, or method according to any one of the preceding embodiments, wherein the sliding layer comprises a fluoropolymer.

Embodiment 7: The bearing, assembly, or method according to any one of the preceding embodiments, wherein the substrate comprises a metal.

Embodiment 8: The bearing, assembly, or method according to any one of the preceding embodiments, wherein the substrate comprises a porous metallic is selected from a mesh material, a grid, an expanded sheet, or a perforated sheet.

Embodiment 9: The bearing, assembly, or method according to any one of the preceding embodiments, wherein the substrate includes aluminum, magnesium, zinc, iron, or an alloy thereof.

Embodiment 10: The bearing, assembly, or method according to any one of the preceding embodiments, wherein the sliding layer comprises a polytetrafluoroethylene (PTFE), a polyamide (PA), a polyether ether ketone (PEEK), a polyimide (PI), a polyamideimide (PAI), a polyphenylene sulfide (PPS), a polyphenylene sulphone (PPSO2), a liquid crystal polymers (LCP), perfluoroalkoxypolymer (PFA), polyoxymethylene (POM), polyethylene (PE), UHMWPE, or a mixture thereof.

Embodiment 11: The bearing, assembly, or method according to any one of the preceding embodiments, wherein the sliding layer comprises a polytetrafluoroethylene (PTFE).

Embodiment 12: The bearing, assembly, or method according to any one of the preceding embodiments, wherein the sliding layer comprises a polyamide (PA), a polyether ether ketone (PEEK), a polyimide (PI), a polyamideimide (PAI), a polyphenylene sulfide (PPS), a polyphenylene sulphone (PPSO2), a liquid crystal polymers (LCP), perfluoroalkoxypolymer (PFA), polyoxymethylene (POM), polyethylene (PE), UHMWPE, ethylene propylene diene, aromatic polyester, or a mixture thereof.

Embodiment 13: The bearing, assembly, or method according to any one of the preceding embodiments, wherein the sliding layer comprises a filler comprising ceramic materials, carbon, glass, graphite, aluminium oxide, molybdenum sulfide, bronze, and silicon carbide.

Embodiment 14: The bearing, assembly, or method according to any one of the preceding embodiments, wherein the sliding layer has a thickness of at least about 0.05 mm, such as at least about 0.1 mm, at least about 0.15 mm, at least about 0.2 mm, at least about 0.25 mm, at least about 0.3 mm, at least about 0.35 mm, at least about 0.4 mm, or at least about 0.45 mm.

Embodiment 15: The bearing, assembly, or method according to any one of the preceding embodiments, wherein the sliding layer has a thickness of not greater than about 5 mm, not greater than about 4 mm, not greater than about 3 mm, not greater than about 2.5 mm, not greater than about 2 mm, not greater than about 1.5 mm, not greater than about 1 mm, not greater than about 0.9 mm, not greater than about 0.8 mm, not greater than about 0.7 mm, not greater than about 0.6 mm, not greater than about 0.55 mm, or not greater than about 0.5 mm.

Embodiment 16: The bearing, assembly, or method according to any one of the preceding embodiments, wherein the substrate has a thickness of at least about 0.05 mm, such as at least about 0.1 mm, at least about 0.15 mm, at least about 0.2 mm, at least about 0.25 mm, at least about 0.3 mm, at least about 0.35 mm, at least about 0.4 mm, or at least about 0.45 mm.

Embodiment 17: The bearing, assembly, or method according to any one of the preceding embodiments, wherein the substrate has a thickness of not greater than about 5 mm, not greater than about 4 mm, not greater than about 3 mm, not greater than about 2.5 mm, not greater than about 2 mm, not greater than about 1.5 mm, not greater than about 1 mm, not greater than about 0.9 mm, not greater than about 0.8 mm, not greater than about 0.7 mm, not greater than about 0.6 mm, not greater than about 0.55 mm, or not greater than about 0.5 mm.

Embodiment 18: The bearing, assembly, or method according to any one of the preceding embodiments, wherein the substrate is embedded in the sliding layer.

Embodiment 19: The method according to embodiment 3, further comprising: cutting a blank from the bearing material; and forming a semi-finished bearing from the blank.

Note that not all of the features described above are required, that a region of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, however, the benefits, advantages, solutions to problems, and any feature(s) that may cause any benefit, advantage, or solution to occur or become more pronounced are not to be construed as a critical, required, or essential feature of any or all the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

The specification and illustrations of the embodiments described herein are intended to provide a general understanding of the structure of the various embodiments. The specification and illustrations are not intended to serve as an exhaustive and comprehensive description of all of the elements and features of assembly and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

### EXAMPLES

Bearing materials according to embodiments described herein were tested for coefficient of friction and wear resistance. A bearing material according to embodiments disclosed herein, C, was tested where the bearing material included a metal substrate, and a sliding layer overlying the substrate, wherein the sliding layer including polytetrafluoroethylene and fillers including wollastonite in a wt % range between 10 and 30%, barium sulfate in a wt % range between 5 and 15%, and pigment in a wt % range between 0.1 and 5% of the total weight of bearing material. Specifically, the wollastonite is wollastonite in a wt % of 19%, the barium sulfate is a barium sulfate in a wt % of 8% and the pigment is an ultramarine violet in a wt % of 3%.

The bearing materials were measured in a journal bearing with a rotating shaft within a housing measuring friction force, normal force, temperature, and wear depth. The cylindrical bushing containing the bearing material had an inner diameter of about 25 mm, a width of about 25 mm, a thickness of between about 0.5 and 1.5 mm, and a clearance of about 50 to about 80 μm. The mating surface was Steel 1.1228 with a hardness of greater than 58 HRC and a surface roughness of between about 0.1 and about 0.2 μm. The shaft was rotated continuously with 4 different pressure and velocity conditions at about 23° C. for about 300 hours. The 4 different PV conditions and results of bearing material C according to embodiments herein and bearing material A known in the art were as follows in Table 1:

| | | | | Material C | Material A | | |
|---|---|---|---|---|---|---|---|
| p | v | n | pv | ave. k-factor | ave. k-factor | Material C | Material A |
| [N/mm²] | [m/s] | [rpm] | [N/mm² · m/s] | [×10⁶ mm³/Nm] | [×10⁶ mm³/Nm] | ave. COF | ave. COF |
| 0.21 | 0.54 | 413 | 0.113 | 0.21 | 1.64 | 0.35 | 0.43 |
| 4.8 | 0.06 | 44 | 0.278 | 0.03 | 1.12 | 0.27 | 0.30 |
| 15 | 0.02 | 15 | 0.300 | 0.09 | 0.44 | 0.17 | 0.16 |
| 70 | 0.01 | 5 | 0.455 | 0.23 | 0.43 | 0.05 | 0.06 |

Conventionally, a lower wear rate is coupled often to a higher coefficient of friction value. However, as shown in Table. 1, bearing material C according to embodiments herein indicates a surprisingly lower wear rate and a comparable coefficient of friction versus the bearing material A known in the art under the testing.

FIG. 3 illustrates a line graph of coefficient of friction vs. time of bearing material C against a bearing material A known in the art. Four tests were done to provide this line graph including the bearing materials were tested against 3 steel balls (3 balls on plate setup tribometer test), each with a diameter of 6 mm, and stainless steel grade (1.3505). The ball bearing force of about 4 N with a rotation velocity of about 0.3 m/s and under a time of about 50 hours. As shown in FIG. 3, the bearing material C shows surprisingly improved coefficient of friction against known bearing material A.

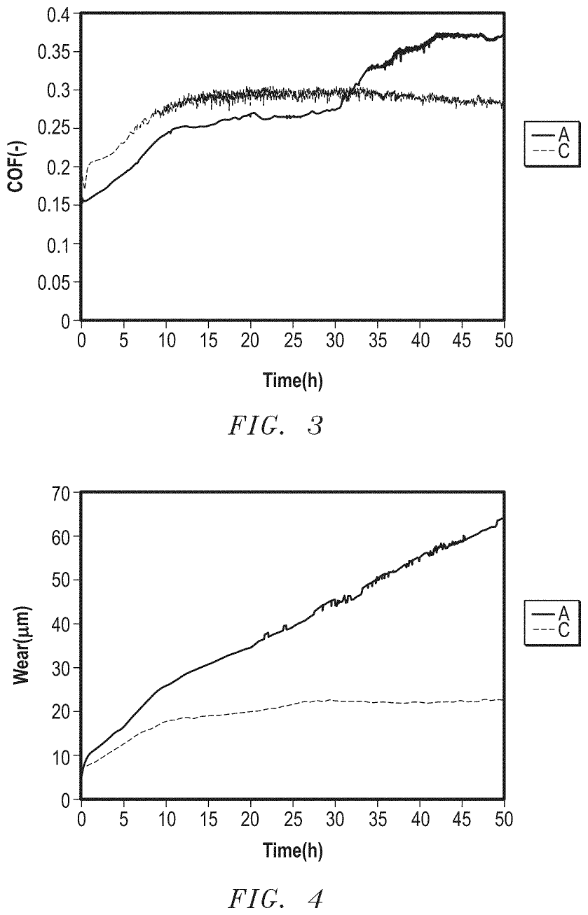

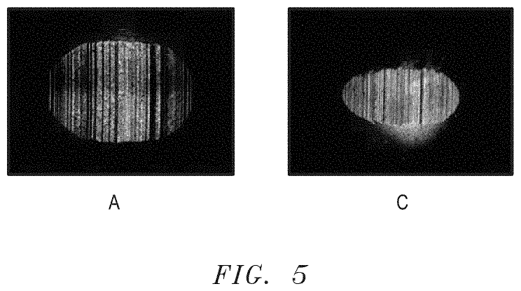

FIG. 4 illustrates a line graph of wear depth in μm vs. time of bearing material C against a bearing material A known in the art. Four tests were done to provide this line graph including the bearing materials were tested against 3 steel balls (3 balls on plate setup tribometer test), each with a diameter of 6 mm, and stainless steel grade (1.3505). The ball bearing force of about 4 N with a rotation velocity of about 0.3 m/s and under a time of about 50 hours. As shown in FIG. 4, the bearing material C show surprisingly improved wear depth against known bearing material A.

FIG. 5 shows the surface of the wear of counterpart of material C and A (steel ball). The steel ball running against material C has a wear rate of between 0.2 μm/h and 0.4 μm/h according to tribometer tests in three balls on plate setup (3 balls on plate setup tribometer test). The steel ball running against material A has the wear rate between 0.8 μm/h and 1.2 μm/h according to tribometer tests in three balls on plate setup (3 balls on plate setup tribometer test). Therefore, as shown in FIG. 5, the bearing material C shows surprisingly improved wear performance of counterpart (steel) against known bearing material A. Further as shown in FIG. 5, the total surface not lined is proportional to the wear rate. Thus, as shown in FIG. 5, the larger the remaining surface after testing (not lined) indicates the higher the wear rate. Therefore, as shown in FIG. 5, the bearing material C shows surprisingly improved wear rate against known bearing material A.

What is claimed is:

1. A bearing material comprising:
a substrate, and
a sliding layer overlying the substrate, wherein the sliding layer comprises fillers comprising wollastonite in a wt % range between 10 and 30%, barium sulfate in a wt % range between 5 and 15%, and pigment in a wt % range between 0.1 and 5%.

2. An assembly comprising:
a first component;
a second component; and
a bearing located between the first component and the second component, the bearing comprising:
a substrate, and
a sliding layer overlying the substrate, wherein the sliding layer comprises fillers comprising wollastonite in a wt % range between 10 and 30%, barium sulfate in a wt % range between 5 and 15%, and pigment in a wt % range between 0.1 and 5%.

3. A method comprising:
providing a substrate;
applying a sliding layer to the substrate to provide a bearing material with a sliding layer overlying the substrate, wherein the sliding layer comprises fillers comprising wollastonite in a wt % range between 10 and 30%, barium sulfate in a wt % range between 5 and 15%, and pigment in a wt % range between 0.1 and 5%.

4. The bearing of claim 1, wherein the bearing has a coefficient of friction of between 0.1 and 0.4 according to tribometer tests in three balls on plate setup.

5. The bearing of claim 1, wherein the bearing has a wear rate of between 0.05 μm/h and 0.15 μm/h according to tribometer tests in three balls on plate setup.

6. The bearing of claim 1, wherein the sliding layer comprises a fluoropolymer.

7. The bearing of claim 1, wherein the substrate comprises a metal.

8. The bearing of claim 1, wherein the substrate comprises a porous metallic is selected from a mesh material, a grid, an expanded sheet, or a perforated sheet.

9. The bearing of claim 1, wherein the substrate includes aluminum, magnesium, zinc, copper, tin, iron, or an alloy thereof.

10. The bearing of claim 1, wherein the sliding layer comprises a polytetrafluoroethylene (PTFE), a polyamide (PA), a polyether ether ketone (PEEK), a polyimide (PI), a polyamideimide (PAI), a polyphenylene sulfide (PPS), a polyphenylene sulphone (PPSO2), a liquid crystal polymers (LCP), perfluoroalkoxypolymer (PFA), polyoxymethylene (POM), polyethylene (PE), UHMWPE, or a mixture thereof.

11. The bearing of claim 1, wherein the sliding layer comprises a polytetrafluoroethylene (PTFE).

12. The bearing of claim 1, wherein the sliding layer comprises a polyamide (PA), a polyether ether ketone (PEEK), a polyimide (PI), a polyamideimide (PAI), a polyphenylene sulfide (PPS), a polyphenylene sulphone (PPSO2), a liquid crystal polymers (LCP), perfluoroalkoxypolymer (PFA), polyoxymethylene (POM), polyethylene (PE), UHMWPE, ethylene propylene diene, aromatic polyester, or a mixture thereof.

13. The bearing of claim 1, wherein the sliding layer comprises a filler comprising ceramic materials, carbon, glass, graphite, aluminium oxide, molybdenum sulfide, bronze, and silicon carbide.

14. The bearing of claim 1, wherein the sliding layer has a thickness of at least about 0.05 mm.

15. The bearing of claim 1, wherein the sliding layer has a thickness of not greater than about 5 mm.

16. The bearing of claim 1, wherein the substrate has a thickness of at least about 0.05 mm.

17. The bearing of claim 1, wherein the substrate has a thickness of not greater than about 5 mm.

18. The bearing of claim 1, wherein the substrate is embedded in the sliding layer.

19. The method of claim 3, further comprising:
cutting a blank from the bearing material; and
forming a semi-finished bearing from the blank.

20. The bearing of claim 1, wherein the sliding layer further comprises an adhesive.
